(19) United States
(12) Patent Application Publication
(10) Pub. No.: US 2007/0078760 A1
(43) Pub. Date: Apr. 5, 2007

(54) Authentication by owner to shared payment instruments

(76) Inventors: Sheldon Conaty, Dublin (IE); Denis Hennessy, Wicklow (IE)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/545,350

(22) PCT Filed: Feb. 13, 2004
(86) PCT No.: PCT/IE04/00022

§ 371 Date: May 23, 2006

Related U.S. Application Data
(60) Provisional application No. 60/447,196, filed on Feb. 13, 2003.

(51) Int. Cl. G06Q 40/00

(52) U.S. Cl. 705/39; 705/44

(57) ABSTRACT

The present invention provides a system and method which allows a primary instrument holder to allow limited and secure use of a payment instrument by a third party. The primary instrument holder is not required to communicate with the third party during a transaction and is not required to carry any specialized hardware to be notified of a transaction, authorize a transaction or deny authorization for a transaction. Pre-established business rules are used to determine the conditions under which the primary account holder is notified of a particular transaction. According to an illustrative embodiment of the present invention, a virtual payment instrument is provided to an authorized third party. The virtual payment instrument acts as a proxy to a primary payment instrument held by the primary instrument holder. The virtual payment instrument may be used by the third-party instead of the primary payment instrument that is held by the primary instrument holder. In an illustrative embodiment, a primary instrument holder nominates a payment instrument to be a primary payment instrument that can be indirectly used by a third party. The instrument provider or service provider such as a bank, credit institution, wireless payment service provider or the like, records any information that is required to identify the primary instrument. The instrument provider or service provider then issues a proxy instrument to the third party. The proxy instrument contains information linking it to the primary instrument and can be used in place of the primary instrument subject to a set of pre-established business rules agreed to by the primary instrument holder. The business rules include conditions under which the primary instrument holder must be contacted for authorization. Pre-established business rules can also be used to automatically decline or allow certain transaction categories. To use the proxy instrument in a payment transaction the third party first presents the proxy instrument to a payee such as a merchant. The payee submits a payment request to a payment processor. The payment processor recognizes that the payment request references a proxy instrument. The payment processor then retrieves identification of the primary instrument using key information contained on the proxy instrument and accesses the business rules associated with the proxy instrument. The payment processor then applies the business rules to the particular transaction to determine whether the transaction must automatically be authorized, automatically declined, or whether the primary account holder must be contacted for authorization.

### RELATED CASE INFORMATION

The present application claims benefit of Provisional Application No. 60/447,196 filed Feb. 13, 2003 and is incorporated herein in its entirety.

### FIELD OF THE INVENTION

The present invention relates to electronic payment systems, and more particularly to shared payment instruments for use in electronic payment systems.

### BACKGROUND OF THE INVENTION

Methods of consumer payment to merchants using established accounts with lenders and financial institutions are well known and include for example, credit card payment methods, debit card payment methods, electronic funds transfers and on-line payment methods. Several methods of consumer payment require consumers to use a payment instrument to process transactions through a payment system.

To perform consumer transactions using a payment instrument such as a credit card, the payment instrument or information identifying the instrument must be presented to a payment processor capable of processing that type of instrument. The consumer may typically submit the instrument, or information to identify the instrument to a merchant having access to the payment processor or may swipe an electronically readable instrument through a card reader in communication with the payment processor. In some instances, the payment processor requests authentication details from the consumer to confirm the consumer's identity and right to use the instrument before the transaction is allowed to proceed. Once the presenter's right to use the instrument is confirmed, the payment processor will transfer payment funds from the consumer's account to the merchant's account.

There are many individuals who may not wish to have a payment instrument on an account of their own, for example, if their need for such an instrument would be infrequent or of limited value to the individual. Some individuals do not have access to payment instruments because they do not qualify for a particular credit account etc. However, such individuals often encounter situations which require a credit instrument or in which access to a credit instrument would be a great convenience. Such individuals may wish to borrow someone else's payment instrument for a limited time or for a particular transaction.

Accordingly, there are many occasions when a typical payment instrument holder desires to share access to a payment instrument, for example, to allow a third party to use the payment instrument for making a purchase using the account of the instrument holder. The instrument holder may, for example, allow the third party to borrow a credit card for a prescribed time and/or to make purchases for a prescribed amount. For example, parents often wish to allow their children to have limited use of a credit instrument. However, once the payment instrument is handed to the third party, the primary instrument holder effectively loses control of the instrument. Accordingly, the third party must be trusted to use the payment instrument within the prescribed parameters.

In order to use a borrowed instrument, a third party must often be given access to any authentication information associated with the instrument such as a personal identification number (PIN) or password. Disclosure of such information to a third party compromises the security of the payment instrument because the third-party may use the instrument identification and authentication information to process transactions without the primary instrument holder's consent, even after the instrument has been returned.

Another disadvantage of allowing a third-party to borrow a payment instrument is that the third party may refuse to return the instrument to the primary instrument holder. If such refusal occurs, the primary instrument holder must typically suffer the inconvenience of canceling the payment instrument with the payment service provider and requesting a substitute instrument with different identification and authentication information. The primary instrument holder is often held liable for unauthorized purchases made by the third party before the instrument is cancelled.

Certain payment instruments are designed for limited use by third parties. For example, some employer credit card accounts allow an employee to use a credit card linked to that account for limited purposes associated with the business of the employer. The employer can typically limit use of such cards by designating certain classes of merchants from which an employee may not purchase goods. Such limited use payment instruments are not useful to average consumers who simply wish to allow third party use of a payment instrument for any type of purchase.

U.S. Pat. No. 4,873,422 to Dethloff discloses a programmable credit card that is issued to a consumer as a primary instrument holder. The card can be programmed by the primary instrument holder for use by a third party. The payment instrument described in the Dethloff patent allows the primary instrument holder to set criteria by which the third party may use the card. For example, the primary instrument holder may program a maximum amount of money that can be charged to the card and/or a time period in which the third party may use the card. The primary instrument holder is thereby allowed some control over the ways in which the third party may use the card.

Although known employer payment card accounts and the programmable credit card described in the Dethloff patent each provide a primary instrument holder with some ability to control third party's use of their payment instrument, they do not permit an primary instrument holder to exercise this control remotely and based on circumstances surrounding the transaction.

U.S. Pat. No. 5,615,110 to Wong discloses a system and method in which a primary instrument holder is notified when the instrument is used for a transaction. If a transaction is executed by a third party or is of a particular type, then the primary instrument holder is notified electronically. The primary instrument holder is thereby given the opportunity to deny authorization and stop the transaction by contacting a computer account writing system, for example via telephone. If a transaction authorization has not been denied after a pre-established period of time, then the computer account writing system proceeds to process the transaction. This system suffers the disadvantage of allowing transactions that would be denied in cases where the primary account holder is unreachable, indisposed or otherwise unable to contact the computer account writing system within the pre-established period of time following an authorization request.

The system and method disclosed in the Wong patent also requires a primary account holder to carry specialized hardware. In particular, the primary instrument holder must have an account receiver for receiving transaction information. Carrying such specialized hardware at all times is an inconvenience that would be unacceptable to typical primary instrument holders who simply wish to allow limited use of a payment instrument to a third party on an occasional basis.

U.S. Pat. No. 5,999,596 to Walker et al, enables a primary instrument holder to control a third party's use of a payment instrument. The Walker patent discloses a system and method for enabling a primary instrument holder to communicate with a third party who is using the payment instrument to execute a transaction with a merchant. The primary instrument holder is notified of each transaction and asked if he would like to communicate with the third party. The primary instrument holder is given the opportunity to authorize or decline the transaction based on the communication with the third party.

The system and method disclosed in the Walker patent is not useful in many instances wherein a primary instrument holder does not wish to communicate with the third party to authorize a transaction. For example, in cases where a credit card is stolen, the primary account holder will not likely wish to engage the unauthorized user in conversation. Such communications with a third party could result in unwanted pressure or intimidation of the primary account holder by the third party who may or may not be an authorized user.

### SUMMARY OF THE INVENTION

The present invention provides a system and method which allows a primary instrument holder to allow limited and secure use of a payment instrument by a third party. The primary instrument holder is not required to communicate with the third party during a transaction and is not required to carry any specialized hardware to be notified of a transaction, authorize a transaction or deny authorization for a transaction. Pre-established business rules are used to determine the conditions under which the primary account holder is notified of a particular transaction.

According to an illustrative embodiment of the present invention, a virtual payment instrument is provided to an authorized third party. The virtual payment instrument acts as a proxy to a primary payment instrument held by the primary instrument holder. The virtual payment instrument may be used by the third-party instead of the primary payment instrument that is held by the primary instrument holder.

In an illustrative embodiment, a primary instrument holder nominates a payment instrument to be a primary payment instrument that can be indirectly used by a third party, The instrument provider or service provider such as a bank, credit institution, wireless payment service provider or the like, records any information that is required to identify the primary instrument. The instrument provider or service provider then issues a proxy instrument to the third party.

The proxy instrument contains information linking it to the primary instrument and can be used in place of the primary instrument subject to a set of pre-established business rules agreed to by the primary instrument holder. The business rules include conditions under which the primary instrument holder must be contacted for authorization. Pre-established business rules can also be used to automatically decline or allow certain transaction categories.

To use the proxy instrument in a payment transaction, the third party first presents the proxy instrument to a payee such as a merchant. The payee submits a payment request to a payment processor. The payment processor recognizes that the payment request references a proxy instrument. The payment processor then retrieves identification of the primary instrument using key information contained on the proxy instrument and accesses the business rules associated with the proxy instrument. The payment processor then applies the business rules to the particular transaction to determine whether the transaction must automatically be authorized, automatically declined, or whether the primary account holder must be contacted for authorization.

If automatic approval or denial of a particular transaction is indicated by application of the business rules then such action is performed by the payment processor. If application of the pre-established business rules indicate that the primary instrument holder must be contacted for authorization, then the payment processor locates the instrument holder's contact information. Using the instrument holder's contact information, the payment processor sends a message to the instrument holder notifying him of the transaction parameters and requesting authorization for the transaction.

The instrument holder can then communicate with the payment processor to authorize the transaction or deny authorization for the transaction. Alternatively, the instrument holder may decide not to respond or may be unable to respond. Pre-established business rules can be used to determine whether a particular category of transaction should be allowed or denied by default if a primary instrument holder does not respond within a period of time which can also be specified in the pre-established business rules. In an illustrative embodiment of the invention, the authorization process can be automated and performed by the payment processor according to pre-established business rules without human intervention.

If the primary instrument holder denies authorization for the transaction, the payment processor so notifies the payee and/or the third party and the transaction is terminated. If the instrument holder authorizes the transaction, the payment processor performs a payment transaction to fulfill the payment request. The payment processor then sends a confirmation message to the instrument holder and optionally to the third party.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a schematic diagram of the various components of a payment processing system according to an illustrative embodiment of the present invention;

FIG. 2 is an example of a business rule data form for establishing business rules for a pair of proxy instruments associated with a primary payment instrument according to an illustrative embodiment of the present invention;

FIG. 3 is a process flow diagram of a process for issuing a proxy instrument according to an illustrative embodiment of the present invention;

FIG. 4 is a process flow diagram of a process for implementation of a shared payment instrument according to an illustrative embodiment of the present invention; and

FIG. 5 is a process flow diagram of an exemplary issuance and use of a primary payment instrument and associated proxy payment instrument.

### DETAILED DESCRIPTION

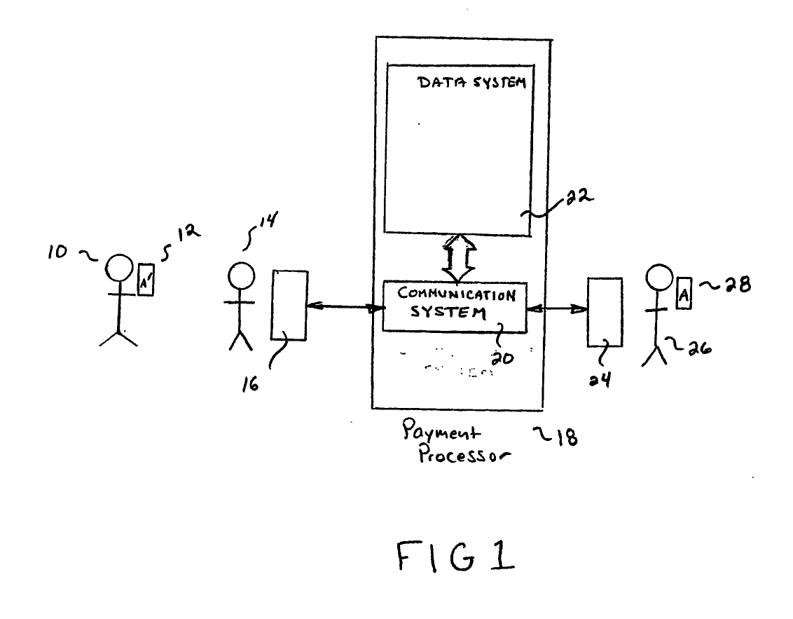

The elements of an illustrative embodiment of a system and method according to the present invention are described first with reference to FIG. 1. A third party 10 holds a proxy instrument 12, such as a credit/debit card or facility linked to a primary holders account. The third party 10 presents the proxy 12 instrument to a merchant 14 in order to purchase goods or services from the merchant 14. The merchant 14 has access to a communication device 16 for communicating information encoded with the proxy instrument to a payment processor 18.

The communication device 16 can be any device capable of transmitting proxy instrument identification data to a payment processor 18 and receiving approval information therefrom. For example, a telephone or conventional credit card reader in communication with the payment processor 18 via telephone lines can be used as a communication device according to the invention. Alternatively, the communication device can be a merchant's mobile telephone or handheld computer (PDA) with wireless communication capabilities. Proxy instrument identification data and approval information can be communicated using voice communication or text messaging, for example.

The payment processor 18 according to the illustrative embodiment can be a general purpose computer or network or can include a number of separate computer systems such as general purpose computers, data servers or networks of data systems and servers. In the illustrative embodiment, the payment processor 18 invokes a computer program to automatically perform the various processes of the present invention. The payment processor 18 includes memory for storage of the program or program components.

The computer program can be implemented in a particular computer language or a combination of different languages can be stored in one or more particular servers or may be implemented as a combination of web services, for example, that are distributed over a wide area and remotely accessed over the internet or wireless communication networks for example.

The payment processor 18 includes a communication system 20 for communicating with the communication device 16 and a communication device 24 accessible by the primary instrument holder 24. The communication system 20 can be configured for a particular communication protocol or can be multi-modal and adapted for use with a variety of communication devices using the same or different protocols, such as telephone, wireless devices, internet protocol devices and the like.

Although, the primary payment instrument 28 is depicted with the primary instrument holder 26, it should be understood that the primary instrument holder 26 is not required to have the primary instrument 28 in his possession in order to be informed of a transaction according to the present invention. Similarly, it should be understood that the third party 10 is not always required to have the proxy instrument 12 in his possession to make a transaction according to the present invention.

It should be understood that in many implementations of the present invention, the third party 10 need not present the proxy instrument 12 to a merchant 14 in person. For example, a transaction according to the invention can be performed over the internet wherein the third party 10 presents the proxy instrument by typing certain identifying information about the proxy instrument, i.e. a credit card number and expiration date, into an on-line computer for communication to an automated merchant payment system over the internet. In such transactions, the merchant payment system takes the place of the merchant 14 as depicted in FIG. 1. Accordingly, the present invention does not necessarily require human intervention on the merchant side.

In another embodiment, a third party may simply swipe a magnetically encoded card through a magnetic card reader wherein the magnetically encoded card reader is configured to transmit proxy instrument identification information to an automated merchant payment system. Such card readers are commonly used for payment at supermarkets and gas stations. In still another embodiment, proxy instrument identification information may be encoded in a radio-frequency tag (RF tag) in the proxy instrument 12. The third party presents the proxy instrument 12 by holding it near an RF tag reader in communication with the automated merchant payment system.

Using the proxy instrument information received from the merchant 14, the payment processor 18, accesses a primary instrument holder's account information in a data system 22. The data system 22 includes a secure database of account information associated with the primary payment instrument 28 as known in the art.

The database links each proxy payment instrument 12 with its associated primary payment instrument 28. In an illustrative embodiment of the invention, the data system also includes a set of business rules associated with each proxy instrument. The payment processor invokes these business rules to determine whether a particular transaction should be automatically allowed, automatically declined or whether such a transaction requires authorization by the primary instrument holder 28. The business rules can also be used to configure user preferences. For example, in an illustrative embodiment, some primary instrument holders may wish to be notified upon the completion of each transaction regardless of whether authorization was required. Others may not wish to receive any notification for automatically authorized transactions or automatically denied transactions.

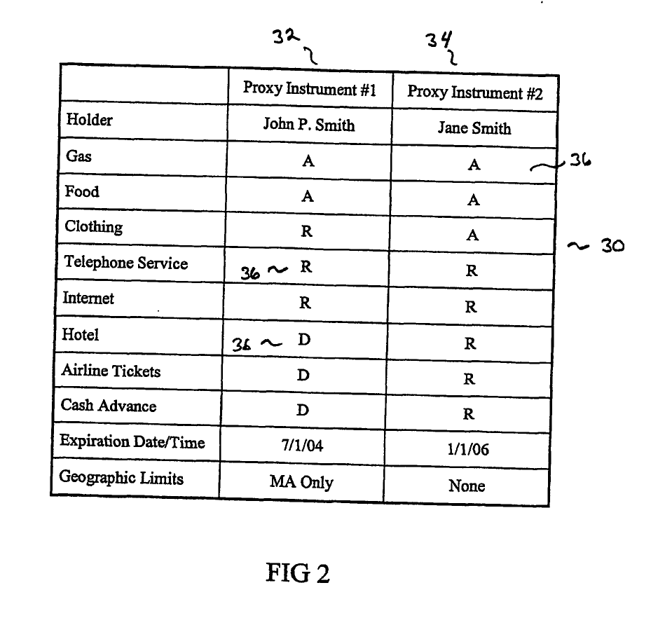

It should be understood that a plurality of proxy instruments may be associated with a single primary payment instrument. Each proxy instrument may be associated with its own set of business rules. For example, a parent may allow several children to carry a proxy instrument associated with one of the parents primary payment instruments. The parent may require different business rules to control each child use of their respective proxy instrument. In an illustrative embodiment, business rules can be configured by a primary account holder by filling out a business rule data form upon applying for issuance of each proxy instrument. FIG. 2 shows an example of a business rule data form 30 that could be used according to an illustrative embodiment of the present invention. Proxy Instrument #1 32 and Proxy Instrument #2 34 are associated with a single primary payment instrument. Transaction response indicators A, R, and D 36 in this example indicate transaction types which are automatically approved (A), automatically declined (D) or which require authorization (R).

If a particular transaction requires authorization by the primary instrument holder, the communication system 20 of the payment processor 18 sends a message to a primary instrument holder's communication device 24. Communication device 24 can be a land based telephone, a mobile telephone, a personal computer, a wireless PDA, or virtually any other type of communication device known in the art that can be configurable to communicate with the communication system 20 of a payment processor 18. The message identifies the proxy instrument being used, the amount of funds requested for payment, and certain information specifying the type of transaction. The message requests that primary account holder approve or decline the transaction. Such approval or denial of the transaction can be performed verbally, in a text response or otherwise encoded according to the type of communication devices being used.

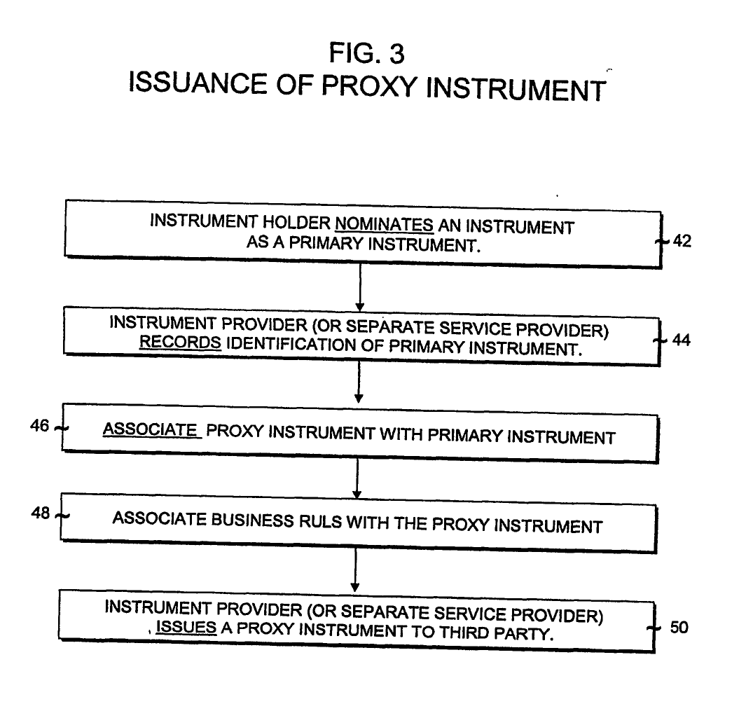

The steps for establishing a proxy instrument account and issuance of a proxy instrument according to an illustrative embodiment of the present invention are described generally with reference to FIG. 3. First an instrument holder nominates an instrument as a primary instrument 42. For example, an instrument holder may hold a variety of credit cards and may wish to issue proxy instruments for one of those credits cards.

An instrument provider, such as the credit card company or bank which issues the nominated instrument or a separate service provider records identification of the primary instrument 44. The instrument provider or separate service provider prepares to issue a proxy instrument by associating a proxy instrument with the primary instrument in an account database 46 and by associating business rules with the proxy instrument 48. The instrument provider or separate service provider then issues the proxy instrument to the third party 50.

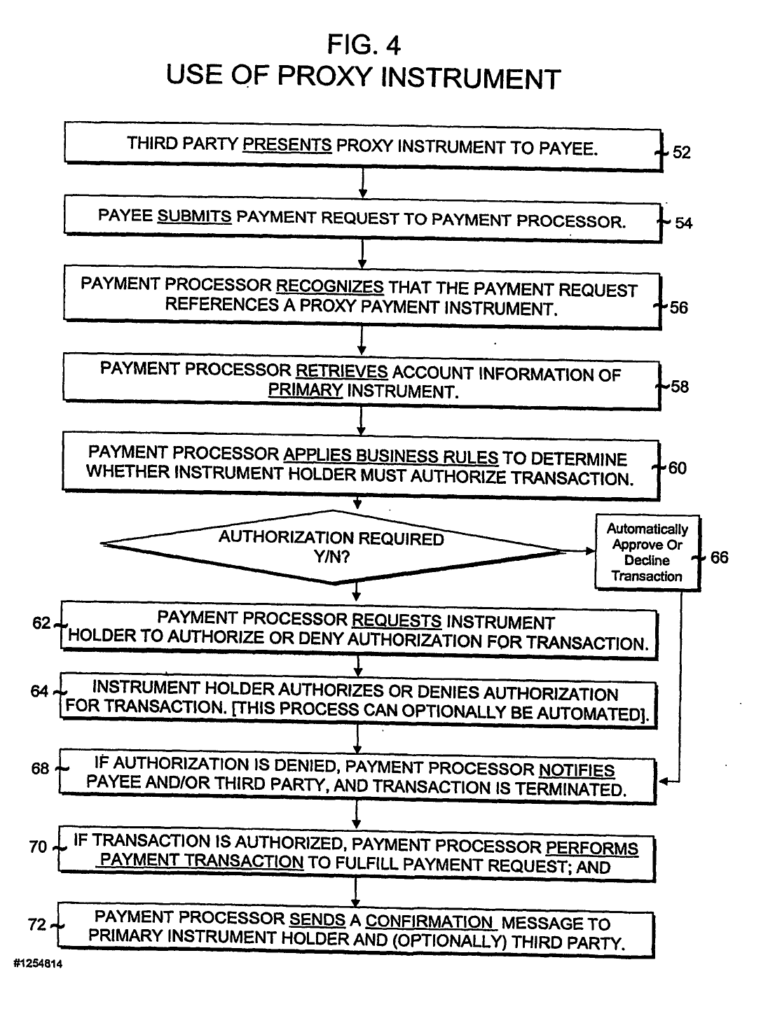

The steps for performing a transaction using a proxy instrument according to an illustrative embodiment of the present invention are described generally with reference to the flow chart of FIG. 4. A third party wishing to make a purchase using a proxy instrument presents the proxy payment instrument to a payee 52. As described hereinbefore, this step may be performed electronically and the payee may be an automated merchant payment system.

The payee submits a payment request to the payment processor 54. The payment processor recognizes that the payment request references a proxy payment instrument 56 and retrieves account information associated with the primary payment instrument 58. The account information associated with the primary payment instrument includes business rules associated with the proxy payment instrument. The payment processor applies business rules associated with the proxy instrument to determine whether the instrument holder must authorize the transaction 60.

If the business rules indicate that the transaction must be authorized by the primary instrument holder, then the payment processor requests the instrument holder to authorize or deny authorization for the transaction 62. The payment processor then authorizes or denies the transaction by communicating back to the payment processor 64.

If the business rules indicate that the transaction need not be authorized by the primary instrument holder, then the payment processor automatically approves or denies the transaction according to the business rules 66.

If authorization is denied, the payment processor notifies the payee and or third party and the transaction is terminated 68. If the transaction is authorized, the payment processor performs the payment transaction to transfer funds to the payee and fulfill the payment request 70. The payment processor then sends a confirmation message to the primary instrument holder and (optionally) to the third party 72.

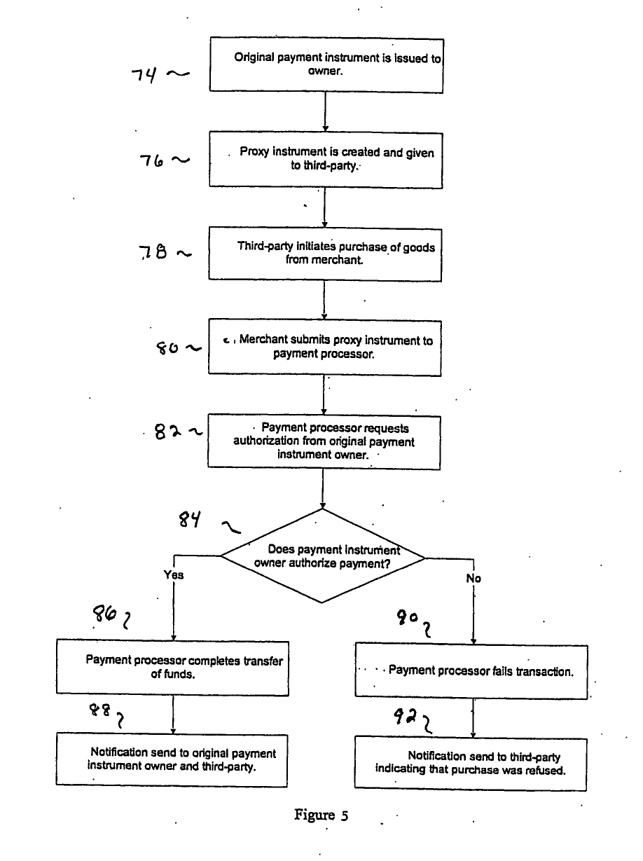

A system embodying the invention will now be described, by way of example, with reference to the drawing; FIG. 5 which is a flow diagram of an exemplary proxy payment instrument transaction. In the exemplary use of the system and method according to the present invention, a parent is provided with a mechanism for safely and conveniently sharing a credit card with one of their children.

The parent registers the credit card information with an on-line payment processor service 74. The payment service is capable of capturing funds from the credit card to pay for purchases.

The parent indicates to the payment processor that the credit card may be shared with a third-party, in this case their child. The payment processor creates a new proxy payment instrument and issues it to the child 76. Internally the payment processor records the information required to link the proxy instrument with the parent's credit card.

Once the proxy payment instrument has been issued to the child they can then use it to make a purchase. For example, a child may wish to purchase call time credit for their mobile phone (this operation is generally referred to as mobile top-up) from a merchant. The child submits their proxy payment instrument to the merchant and request 10 euros worth of call credit 78.

The merchant in turn submits the instrument details to the payment processor 80 so that the merchant can transfer 10 euros from the payment instrument account into their own.

The payment processor identifies that the payment instrument submitted is actually a proxy instrument. It then retrieves the information, in storage, associated with the proxy instrument. From the retrieved information, the payment processor identifies the parent who owns the credit card and any details required to identify the original payment instrument. The payment processor determines that the parent needs to authorize the call credit purchase which was initiated by their child. It publishes a message to the parent's mobile phone asking if the purchase is acceptable 82. An example of the message might be:

“Bobby, using your ‘personal visa card’ wants to spend 10 euros at ‘Jake's Top-Up Service’. Is this acceptable?”

The parent receives the notification on their phone 84 and replies indicating if the transaction is acceptable.

If the parent indicates that the purchase is allowed, the payment processor will capture the funds 86 and transfer the money to the merchant. It can then notify both the parent and child, over their mobile phones, affirming that the purchase completed successfully 88. However, if the parent replies stating that the purchase is not allowed then the transaction will be cancelled 90 and the merchant notified. The payment processor can then send a “Purchase refused” message to the child's mobile phone 92.

The above example demonstrates several benefits of the present invention. For example, the child does not directly receive access to the parent's credit card and hence cannot use it for purchases outside the system described. The parent has full control over the use of their credit card by the child. Also the child is able to purchase goods using a credit card even though they are below the legal age required to hold one.

Although, the various embodiments have been described generally in terms of credit card instruments, it should be understood that the present invention can also be implemented using a variety of payment instrument types and virtual payment instruments. For example, it is envisioned that a primary account can be accessed using only certain authentication information, such as an account number, PIN and/or password. A proxy instrument may also be embodied as simply an account number, a PIN and/or password without the actual issuance of any physical token such as a credit card.

Although the various embodiments of the invention are described herein generally in terms of a configurable set of business rules, it should be understood that various embodiments of the invention can be implemented with simple fixed business rules or without business rules at all. For example, an illustrative embodiment of the invention can be implemented in which every transaction using a proxy instrument must be authorized by a primary instrument holder.

Although the system and method of the invention is described with respect to several illustrative embodiments thereof, it should be appreciated that the foregoing and various other changes, omissions, additions in the form and detail thereof could be implemented without changing the underlying invention or departing from the spirit and scope of the present invention.

1. A method for securely sharing a payment instrument comprising:
issuing an original payment instrument to an owner;
providing an associated proxy instrument to a third party wherein said proxy instrument has access to information for identifying said original payment instrument associated therewith;
submitting said proxy instrument to a merchant to initiate a purchase;
submitting said proxy instrument by a merchant to a payment processor;
determining whether said purchase requires authorization from said owner;
transferring funds to complete said purchase if authorization is not required;
requesting authorization from said owner if required;
transferring funds to complete said purchase if authorization is received from said owner;
declining said purchase if authorization is not received from said owner;
notifying said owner and said third party that said transaction is complete or that said transaction was declined.

2. The method according to claim 1 wherein said requesting step is performed by publishing a message to said owner's mobile phone.

3. The method according to claim 1 wherein said authorization is received from said owner in a message from said owner's mobile phone.

4. A system for charging purchases by a third party to an account of a primary instrument holder comprising:
a primary payment instrument associated with an account;
a proxy payment instrument associated with the primary payment instrument;
and
a payment processor configured for authorizing, declining or requesting authorization for a purchase from a primary instrument holder.

5. The system according to claim 4 wherein said payment processor is configured to request, decline or request authorization for a purchase from a primary instrument holder according to pre-established business rules.

6. The system according to claim 5 further comprising a first communication device in communication with payment processor wherein said first communication device is configured to communicate transaction information and proxy instrument information to said payment processor and receive transaction approval or denial information therefrom.

7. The system according to claim 6 wherein said first communication devices comprises a mobile telephone.

8. The system according to claim 6 wherein said first communication device comprises a card reader having a telephone connection to said payment processor.

9. The system according to claim 4 further comprising a second communication device in communication with the payment processor wherein said second communication device is configured to receive a request for approval of a payment transaction from said payment processor to a primary instrument holder and configured to send an authorization or denial of approval to said payment processor.

10. The system according to claim 9 wherein said second communication device comprises a mobile telephone.

11. The system according to claim 4 wherein said payment processor comprises:
a communication system adapted for communicating with a first communication device accessible by a merchant and a second communication device accessible by said primary instrument holder;
a data system in communication with said communication system, said data system configured for storage of account data and operating a database for accessing said data in response queries from said communication system.

12. The system according to claim 4 wherein said payment processor comprises a general purpose computer.

13. The system according to claim 4 wherein said payment processor comprises a distributed network of computers.

14. The system according to claim 4 wherein said payment processor comprises means for communicating messages between a merchant and said payment processor and between a primary instrument holder and said payment processor.

15. The system according to claim 4 wherein said payment processor comprises means for processing payment to facilitate a transaction according to pre-established business rules.

16. A method for securely allowing a third party to make purchases using a primary payment instrument wherein comprising:
associating a proxy instrument with said primary payment instrument;
associating business rules with said proxy instrument; and
issuing said proxy instrument to a third party.

17. The method according to claim 16 further comprising:
said third party presenting said proxy instrument to a payee;
said payee submitting a payment request to a payment processor;
said payment processor recognizing that said payment request references a proxy payment instrument;
said payment processor applying said business rules to determine whether a primary instrument holder must authorize said purchase;
said payment processor requesting said primary instrument holder to authorize or deny said purchase;
said primary instrument holder authorizing or denying authorization for said purchase;
said payment processor notifying said payee and terminating said purchase if said purchase is denied; and
said payment processor performing a payment transaction to facilitate said purchase if said purchase is authorized.

18. The method according to claim 17 further comprising:
said payment processor transmitting a confirmation message to said primary instrument holder upon completion of said purchase.

19. The method according to claim 16 wherein said business rules are configurable by said primary instrument holder.

20. The method according to claim 16 wherein said business rules include a list of transaction categories which are automatically approved, a list of transaction categories which are automatically denied and a list of transaction categories which require authorization by said primary instrument holder.
